(19) United States
(12) Patent Application Publication
(10) Pub. No.: US 2008/0258065 A1
(43) Pub. Date: Oct. 23, 2008

(54) Electromagnetic Energy Propagation Direction Sensor and Method of Using Same

(75) Inventor: Johnny E. Banks, Venus, TX (US)

Correspondence Address: LAW OFFICES OF JAMES E. WALTON, PLLC, 1169 N. BURLESON BLVD., SUITE 107-328, BURLESON, TX, 76028, US

(73) Assignee: LOCKHEED MARTIN CORPORATION, Grand Prairie, TX (US)

(21) Appl. No.: 11/739,022

(22) Filed: Apr. 23, 2007

(51) Int. Cl. G01J 5/00

(52) U.S. Cl. 250/342; 250/338.1; 977/742

(57) ABSTRACT

A sensor for detecting a propagation direction of electromagnetic energy includes a plurality of receptors oriented in different directions for absorbing at least a portion of the electromagnetic energy, each of the plurality of receptors comprising a plurality of carbon nanotubes or nanofibers. The sensor further includes a processor electrically coupled with the plurality of receptors for determining the propagation direction of the electromagnetic energy based upon the electromagnetic energy absorbed by the plurality of receptors. A method for determining a propagation direction of electromagnetic energy includes the steps of providing a plurality of receptors oriented in different directions for absorbing at least a portion of the electromagnetic energy, each of the plurality of receptors comprising a plurality of carbon nanotubes or nanofibers, and determining the propagation direction of the electromagnetic energy with respect to the plurality of receptors based upon the amount of absorbed electromagnetic energy.

### BACKGROUND

1. Field of the Invention

The present invention relates to sensors for determining the propagation direction of electromagnetic energy.

2. Description of Related Art

It is often desirable to determine the direction in which electromagnetic energy propagates. Such electromagnetic energy may be discernable or indiscernible to the human senses. Projectiles, such as rockets, missiles, and the like, for example, are often guided by determining the direction from which electromagnetic energy of a certain wavelength or within a certain range of wavelengths is propagating. For example, a target is illuminated by electromagnetic energy of a certain wavelength, which is reflected by the target. A sensor system on-board the projectile senses the reflected electromagnetic energy and determines the direction from which the electromagnetic energy is propagating. A guidance system of the projectile directs the projectile toward the target, based upon the direction from which the reflected electromagnetic energy is propagating.

Conventional electromagnetic energy propagation direction sensors, however, require expensive lenses or antenna arrays for receiving the reflected electromagnetic energy. Such lenses and antenna arrays occupy a significant volume of a projectile that cannot then be used for payload, propellant, or other systems. Often, the lenses and antenna arrays impact the physical shape of the projectile, thereby inducing additional aerodynamic drag over a more optimum aerodynamic projectile shape. Moreover, such conventional sensors often require significant electrical power, usually provided by batteries, to function. Batteries occupy volume of the projectile and are often heavy, thus impacting the amount of payload, propellant, or other systems on board the projectile.

While there are many designs of electromagnetic energy propagation direction sensors well known in the art, considerable shortcomings remain.

### DESCRIPTION OF THE DRAWINGS

The novel features believed characteristic of the invention are set forth in the appended claims. However, the invention itself, as well as, a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 is a side, elevational view of an illustrative embodiment of a projectile incorporating an electromagnetic energy propagation direction sensor;

FIG. 2 is an enlarged, end elevational view of the projectile of FIG. 1;

FIG. 3 is a top, plan, scanning electron micrograph of a portion of a nanotube aerogel sheet used in one or more receptors of one embodiment of the electromagnetic energy propagation direction sensor of FIG. 1;

FIG. 4 is a side, elevational, scanning electron micrograph of the portion of the nanotube aerogel sheet of FIG. 4;

FIG. 5 is a top, plan, scanning electron micrograph of a sheet array used in one particular embodiment of the electromagnetic energy propagation direction sensor of FIG. 1;

FIG. 6 is a scanning electron micrograph of a portion of buckypaper, representative of buckypaper used in one or more receptors of one embodiment of the electromagnetic energy propagation direction sensor of FIG. 1;

FIG. 7 is an enlarged, side, elevational view of a portion of the projectile of FIG. 1, illustrating a first exemplary operation of the electromagnetic energy propagation direction sensor of FIG. 1;

FIG. 8 is a stylized view of a plurality of projected areas corresponding to the amount of electromagnetic energy absorbed by the plurality of receptors of the electromagnetic energy propagation direction sensor of FIG. 1 for one particular propagation direction of electromagnetic energy;

FIG. 9 is an enlarged, side elevational view of a portion of the projectile of FIG. 1, illustrating a second exemplary operation of the electromagnetic energy propagation direction sensor of FIG. 1;

FIG. 10 is a stylized view of a plurality of projected areas corresponding to the amount of electromagnetic energy absorbed by the plurality of receptors of the electromagnetic energy propagation direction sensor of FIG. 1 for one particular propagation direction of electromagnetic energy;

FIG. 11 is an enlarged, side, elevational view of a portion of an illustrative embodiment of a vehicle depicting an electromagnetic energy propagation direction sensor disposed within the vehicle;

FIG. 12 is a side, elevational view of an illustrative embodiment of a vehicle depicting exemplary locations for electromagnetic energy receptors;

FIG. 13 is a side, elevational view of an illustrative embodiment of a ground-traveling vehicle incorporating an electromagnetic energy propagation direction sensor; and

FIG. 14 is a stylized, side, elevational view of an illustrative embodiment of a structure incorporating an electromagnetic energy propagation direction sensor.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENT

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

A sensor for detecting a propagation direction of electromagnetic energy comprises a plurality of receptors, oriented in different directions, for absorbing portions of the electromagnetic energy. Each of the receptors comprises a plurality of carbon nanotubes or nanofibers. In a preferred embodiment, at least one of the receptors comprises a plurality of carbon nanotubes or nanofibers substantially oriented in a preferred direction in sheet form. In another embodiment, at least one of the receptors comprises a plurality of carbon nanotubes or nanofibers in sheet form, such as “buckypaper.” The sensor further comprises a means for discerning the propagation direction of the electromagnetic energy with respect to the plurality of receptors, based upon the amount of electromagnetic energy absorbed by the receptors. In one embodiment, the plurality of receptors is disposed on an outer surface of a vehicle. Alternatively, the plurality of receptors is disposed within a vehicle behind one or more vehicle elements that are substantially transparent to the electromagnetic energy. It should be noted that the sensor can also be used to transmit and/or receive data for operation of the sensor, a vehicle operatively associated with the sensor, and/or other ancillary equipment.

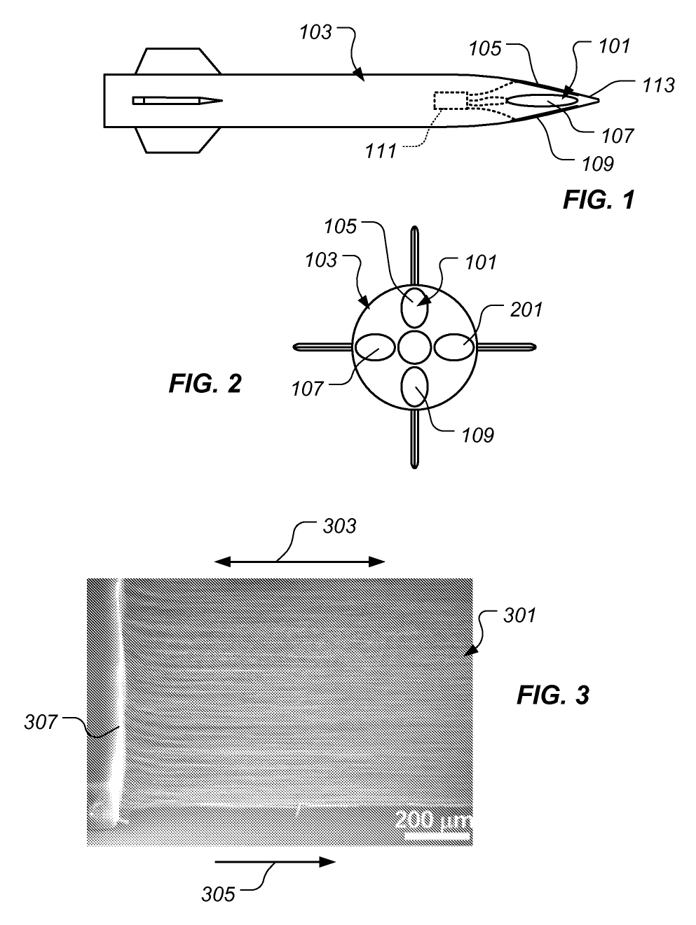

FIGS. 1 and 2 depict an illustrative embodiment of a carbon nanotube-based sensor 101 for detecting a propagation direction of electromagnetic energy encountering sensor 101. Sensor 101 is illustrated as being operatively associated with a projectile 103 (e.g., a missile, a rocket, a torpedo, or the like), although the scope of the present invention is not so limited. Sensor 101 may be freestanding, may be operatively associated with a stationary structure or may be operatively associated with a vehicle. The vehicle may be a ground-traveling vehicle, an airborne vehicle (e.g., a projectile, a missile, a rocket, or the like), or a waterborne vehicle (e.g., a torpedo or the like). Accordingly, even though in the following discussion sensor 101 is described in relation to projectile 103, the scope of the present invention is not so limited.

Sensor 101 comprises a plurality of receptors 105, 107, 109, 201 that absorb portions of electromagnetic energy. Note that receptor 201 is not visible in FIG. 1. In the illustrated embodiment, the plurality of receptors 105, 107, 109, 201 comprises four receptors having particular configurations. The scope of the present invention, however, is not so limited. Rather, sensor 101 may comprise any suitable number of receptors (e.g., receptors 105, 107, 109, 201). Sensor 101 preferably includes three or more receptors oriented in different directions, so that a three-dimensional propagation direction of the electromagnetic energy can be discerned, as will be discussed in greater detail below. Moreover, receptors 105, 107, 109, 201 may exhibit any suitable form and/or shape, depending upon the particular implementation of sensor 101.

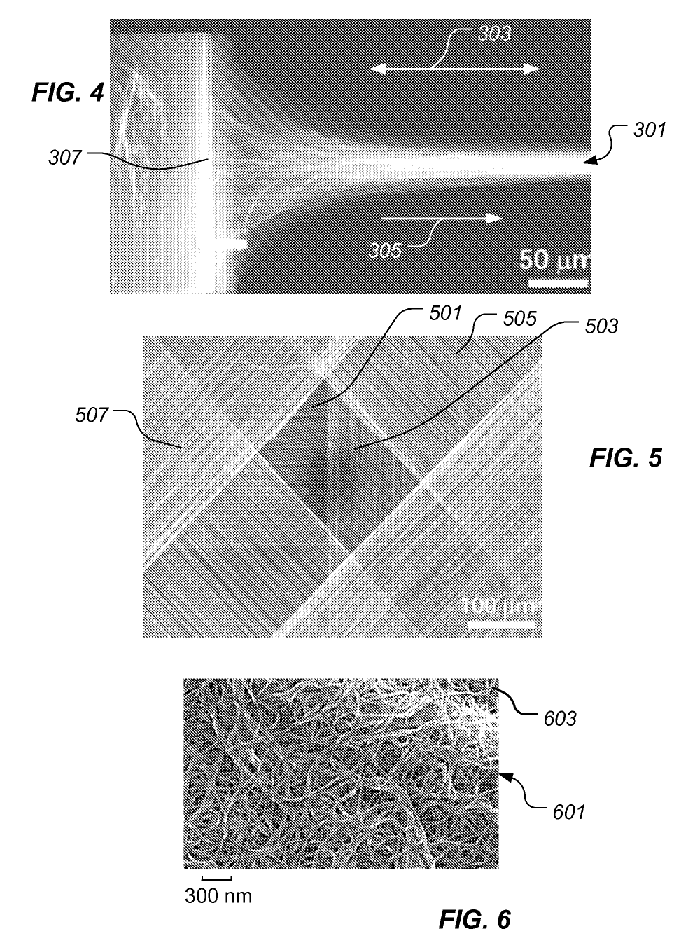

Each of the plurality of receptors 105, 107, 109, 201 comprises a plurality of carbon nanotubes and/or carbon nanofibers. Preferably, one or more of the plurality of receptors 105, 107, 109, 201 comprises a substantially transparent, electronically-conducting, anisotropic nanotube aerogel sheet 301, such as shown in FIGS. 3 and 4, that is subsequently densified, as described in greater detail herein. Nanotube sheet 301 comprises a plurality of carbon nanotubes extending in a direction corresponding to double-headed arrow 303. Nanotube sheet 301 is formed by drawing carbon nanotubes in a direction substantially along an arrow 305 from a sidewall 307 of multiwalled nanotube forests that, in one embodiment, were synthesized by catalytic chemical vapor deposition using acetylene gas as the carbon source. Aerogel sheet 301 is subsequently densified by causing aerogel sheet 301 to adhere to a substrate comprising, e.g., glass plastic, silicon, gold, copper, aluminum, steel, or the like. The substrate with aerogel sheet 301 adhered thereto is immersed in a liquid, such as ethanol, substantially along the nanotube alignment direction, e.g., along arrow 303, then retracting the substrate from the liquid. Surface tension effects during liquid evaporation shrink the thickness of aerogel sheet 301. Moreover, aerogel sheet 301 can be adhered to a substrate by contacting aerogel sheet 301 with a liquid, such as ethanol, and allowing evaporation to densify aerogel sheet 301. Carbon nanotube-laden, densified, aerogel sheets produced by the NanoTech Institute, University of Texas at Dallas, Richardson, Tex., US, such as that described in Mei Zang et al., Strong, Transparent, Multifunctional, Carbon Nanotube Sheets, 309 Science 1215 (2005), which is incorporated herein by reference for all purposes, is particularly well suited for the plurality of receptors 105, 107, 209, 201.

Referring to FIG. 5, it should be noted that a plurality of plies or layers 501, 503, 505 forest-drawn carbon nanotube sheets can be assembled into a sheet array 507 and as conducting layers on non-planar surfaces, such as by helically wrapping a sheet strip on a cylinder. Chiral structures, which may be desirable in certain implementations wherein long infrared and microwave wavelengths of radiation are of interest, can be made by stacking parallel sheets so that the orientation direction varies helically along the stack thickness and then densifying the stacked array. It should be noted, however, that the present invention is not limited to the particular configurations of stacked arrays depicted in FIG. 5 and described herein. Rather, the scope of the present invention encompasses any suitable configuration of stacked arrays.

Alternatively, one or more of the plurality of receptors 105, 107, 109, 201 comprises a plurality of carbon nanotubes or nanofibers prepared in an intertwined, mat form, such as “buckypaper.” such as the buckypaper produced by the Florida Advanced Center for Composite Technologies, Florida A&M University-FSU College of Engineering, Tallahassee, Florida. One such example is shown in FIG. 6, which provides a scanning electron micrograph of a portion of buckypaper 601 comprising a plurality of carbon nanotubes or nanofibers 603 (only one labeled for clarity). It should be noted that buckypaper and the particular buckypaper material depicted in FIG. 6 are merely exemplary materials for the plurality of receptors 105, 107, 109, 201. Other configurations of nanotubes or nanofibers for the plurality of receptors 105, 107, 109, 201 are contemplated by the present invention, including more structured configurations (e.g., woven

Generally, carbon nanotubes or nanofibers comprise fullerene, e.g., C₆₀. Carbon nanotubes or nanofibers are generally cylindrical (either substantially straight or curved) and may be single-walled or multi-walled. Carbon nanotubes or nanofibers can have electrical current densities more than 1,000 times greater than metals such as silver and copper and, thus, are particularly well suited for receptors 105, 107, 109, 201. The plurality of carbon nanotubes or nanofibers may be doped with other elements to affect their electromagnetic conductivities and/or to affect the wavelength or wavelengths of electromagnetic energy that are preferentially absorbed by the plurality of receptors 105, 107, 109, 201. Moreover, the plurality of receptors 105, 107, 109, 201 may comprise other elements and/or materials to affect the electromagnetic conductivities of the plurality of receptors 105, 107, 109, 201 and/or to affect the wavelength or wavelengths of electromagnetic energy that are preferentially absorbed by the plurality of receptors 105, 107, 109, 201.

Returning now to FIG. 1, sensor 101 further comprises a processor 111 electrically coupled with each of the plurality of receptors 105, 107, 109, 201. Processor 111 determines the propagation direction of the electromagnetic energy striking receptors 105, 107, 109, 201 with respect to receptors 105, 107, 109, 201, as will be discussed in greater detail below.

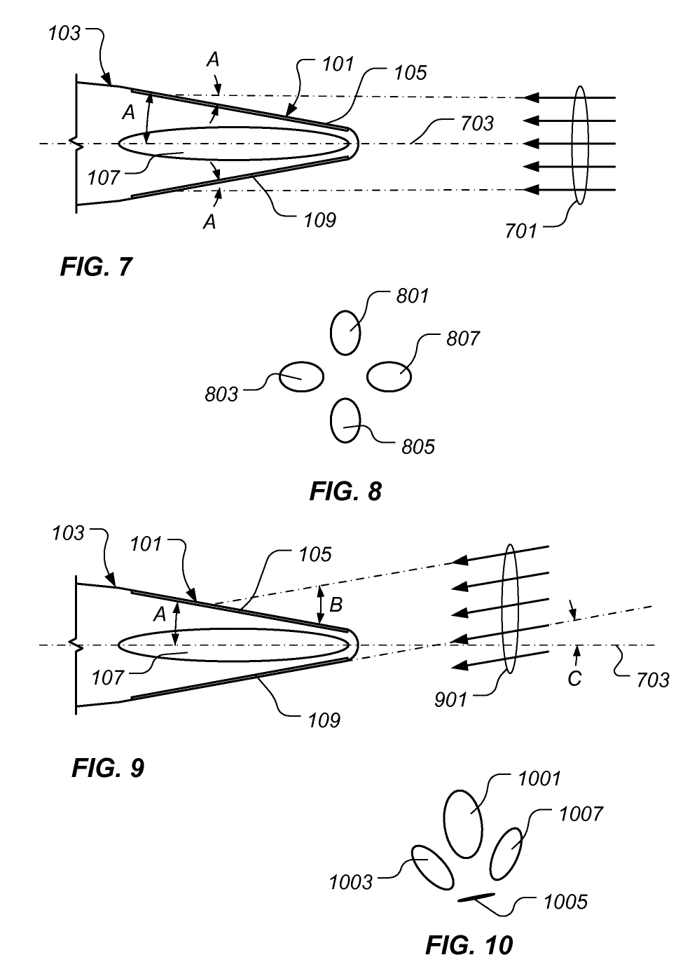

FIGS. 7 and 8 depict a first exemplary operation of sensor 101. In the example illustrated in FIG. 7, electromagnetic energy 701 propagates along a path substantially parallel to a central axis 703 of receptors 105, 107, 109, 201 (receptor 201 shown only in FIG. 2). In this example, the plurality of receptors 105, 107, 109, 201 are disposed substantially symmetrically about central axis 703. Thus, electromagnetic energy 701 strikes each of the plurality of receptors 105, 107, 109, 201 substantially equally and at substantially the same angle A with respect to each of the plurality of receptors 105, 107, 109, 201. In this embodiment, each of the plurality of receptors 105, 107, 109, 201 are inclined with respect to central axis 703 by angle A.

FIG. 8 depicts projected areas 801, 803, 805, 807, as viewed from the propagation path of electromagnetic energy 701 (shown in FIG. 7). Projected areas 801, 803, 805, 807 represent the intercepted portions of electromagnetic energy 701 for the plurality of receptors 105, 107, 109, 201, respectively. Note that areas 801, 803, 805, 807 correspond to the amount of electromagnetic energy absorbed by the plurality of receptors 105, 107, 109, 201, respectively, from electromagnetic energy 701. In this example, areas 801, 803, 805, 807 are substantially equivalent. Thus, the amount of electromagnetic energy 701 absorbed by each of the plurality of receptors 105, 107, 109, 201 is substantially equivalent. Thus, processor 111 (shown in FIG. 1) determines that electromagnetic energy 701 is propagating substantially parallel to central axis 703. It should be noted that, in the illustrated embodiment, central axis 703 is substantially collinear with a longitudinal, flight axis of projectile 103. The scope of the present invention, however, is not so limited. Rather, a longitudinal, flight axis of projectile 103 may be skewed with respect to central axis 703. Processor 111 compensates for such a skewing to determine the propagation direction of electromagnetic energy 701 with respect to the longitudinal, flight axis of projectile 103.

FIGS. 9 and 10 depict a second exemplary operation of sensor 101. Referring to FIG. 9, electromagnetic energy 901 propagates toward sensor 101 along a path that is not parallel to central axis 703. For example, electromagnetic energy 901 strikes receptor 105 at an angle B, while electromagnetic energy strikes receptor 109 at an angle approaching zero.

FIG. 10 depicts projected areas 1001, 1003, 1005, 1007, as viewed from the propagation path of electromagnetic energy 901 (shown in FIG. 9). Projected areas 1001, 1003, 1005, 1007 represent the intercepted portions of electromagnetic energy 901 for the plurality of receptors 105, 107, 109, 201, respectively. As in the previous example, areas 1001, 1003, 1005, 1007 correspond to the amount of electromagnetic energy absorbed by the plurality of receptors 105, 107, 109, 201, respectively, from electromagnetic energy 901. In this example, opposing areas 1003 and 1007 are substantially equivalent, but opposing areas 1001 and 1005 are not. Thus, the amount of electromagnetic energy absorbed by each of receptors 107 and 201 is substantially equivalent, but the amount of electromagnetic energy absorbed by each of receptors 105 and 109 is not. Thus, processor 111 (shown in FIG. 1) determines that electromagnetic energy 901 is propagating at an angle C with respect to central axis 703. If the longitudinal, flight axis of projectile 103 is skewed with respect to central axis 703, processor 111 compensates for the skewing to determine the propagation direction of electromagnetic energy 901 with respect to the longitudinal, flight axis of projectile 103.

There are many ways that processor 111 may determine the propagation direction of electromagnetic energy (e.g., electromagnetic energy 701 or 801) striking the plurality of receptors 105, 107, 109, 201 with respect to central axis 703. The scope of the present invention encompasses all such methods. In one embodiment, processor 111 determines the propagation direction of electromagnetic energy striking the plurality of receptors 105, 107, 109, 201 by comparing the amount of electromagnetic energy absorbed by each of the opposing receptors (e.g., opposing receptors 105, 109 or opposing receptors 107, 201) as a percentage of the total electromagnetic energy absorbed by both of the opposing receptors.

For example, if the percentage of electromagnetic energy absorbed by each of receptors 105, 109 is substantially 50 percent of the total electromagnetic energy absorbed by both of receptors 105, 109 and the percentage of electromagnetic energy absorbed by each of receptors 107, 201 is substantially 50 percent of the total electromagnetic energy absorbed by both of receptors 107, 201 (as in the example of FIGS. 7 and 8), then the electromagnetic energy is propagating substantially parallel to a central axis (e.g., central axis 703) of the plurality of receptors 105, 107, 109, 201. If, as in the example of FIGS. 9 and 10, the amount of electromagnetic energy absorbed by receptor 105 is substantially different from the amount of electromagnetic energy absorbed by receptor 109, expressed as a percentage of the total electromagnetic energy absorbed by receptors 105 and 109, the electromagnetic energy is not propagating parallel to the central axis 703 of the plurality of receptors 105, 107, 109, 201. In this embodiment, processor 111 calculates the propagation angle (e.g., angle C of FIG. 9) with respect to the central axis 703 of the plurality of receptors 105, 107, 109, 201 based upon the difference in the percentage of the electromagnetic energy absorbed by receptors 105 and 109.

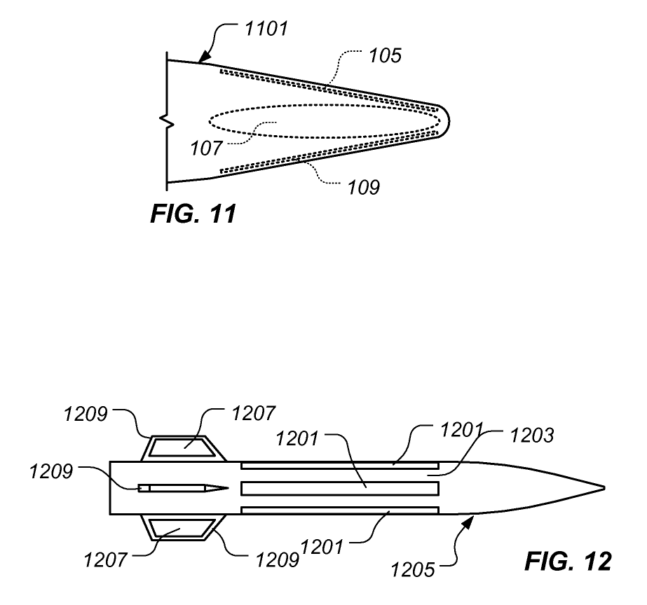

In the embodiment of FIGS. 1, 2, 7, and 9, the plurality of receptors 105, 107, 109, 201 is disposed on an outer surface of projectile 103. Carbon nanotube- or nanofiber-material is particularly suitable for such a construction, because such material exhibits high hardness and mechanical strength. The scope of the present invention, however, is not so limited. Rather, as shown in FIG. 11, one or more of the plurality of receptors 105, 107, 109, 201 (receptor 201 only shown in FIG. 2) may be disposed within projectile 1101, so long as the portion of projectile 1101 disposed between the plurality of receptors 105, 107, 109, 201 and the electromagnetic energy does not electromagnetically shield the plurality of receptors 105, 107, 109, 201 from the electromagnetic energy.

For example, if the electromagnetic energy of interest exhibits one or more wavelengths within the infrared range, the portion of projectile 1101 between the plurality of receptors 105, 107, 109, 201 and the electromagnetic energy must be at least optically translucent to the infrared wavelength or wavelengths of interest, and preferably optically transparent to the infrared wavelength or wavelengths of interest. Similarly, if the electromagnetic energy of interest exhibits one or more wavelengths within the radio frequency range, the portion of projectile 1101 between the plurality of receptors 105, 107, 109, 201 and the electromagnetic energy must be at least translucent to the wavelength or wavelengths of interest, and preferably transparent to the wavelength or wavelengths of interest.

In the embodiments of FIGS. 1, 2, 7, 9, and 11, the plurality of receptors 105, 107, 109, 201 are operatively associated with a nose 113 (shown in FIG. 1) of projectile 103. The scope of the present invention, however, is not so limited. Rather, a sensor (e.g., sensor 101), including any receptors (e.g., the plurality of receptors 105, 107, 109, 201), may be operatively associated with any portion of a projectile (or any other vehicle or structure). For example, as shown in FIG. 12, receptors 1201 are operatively associated with a fuselage 1203 of projectile 1205 and receptors 1207 are operatively associated with control surfaces 1209 of projectile 1205. Other locations for receptors are possible and within the scope of the present invention. As discussed above, the receptors may be disposed within the vehicle or structure or external to the vehicle or structure.

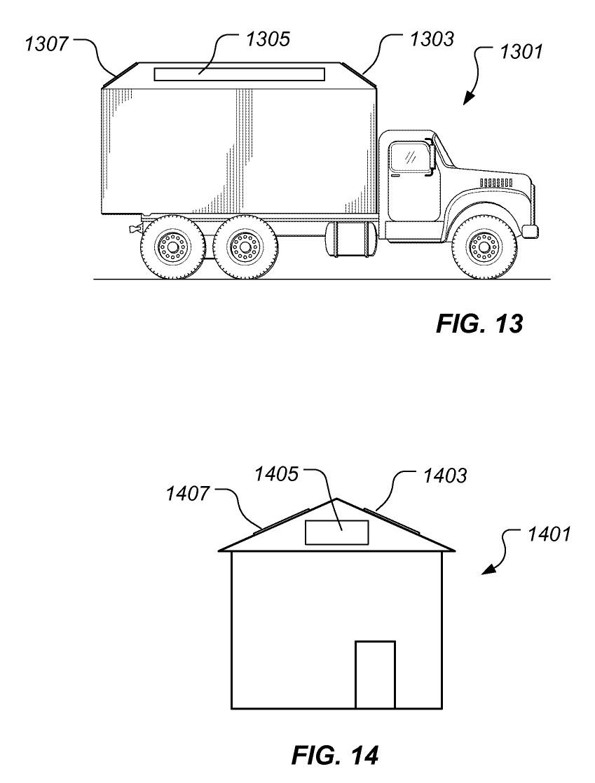

For example, as shown in FIG. 13, a ground-traveling vehicle 1301 includes a plurality of receptors 1303, 1305, 1307 operably associated therewith. It should be noted that the thicknesses of receptors 1303, 1305, 1307 is exaggerated in FIG. 13 for clarity. Ground-traveling vehicle 1301 includes a processor, such as processor 111, for determining the propagation direction of electromagnetic energy striking the plurality of receptors 1303, 1305, 1307, as discussed above. It should further be noted that the scope of the present invention encompasses ground-traveling vehicle configurations other than the configuration of ground-traveling vehicle 1301.

Furthermore, as shown in FIG. 14, a structure 1401 includes a plurality of receptors 1403, 1405, 1407 operably associated therewith. It should be noted that the thicknesses of receptors 1403, 1405, 1407 is exaggerated in FIG. 14 for clarity. Structure 1401 includes a processor, such as processor 111, for determining the propagation direction of electromagnetic energy striking the plurality of receptors 1403, 1405, 1407, as discussed above. It should further be noted that the scope of the present invention encompasses structure configurations other than the configuration of structure 1401.

It should be noted that the receptors described herein (e.g., receptors 105-109, 201 or 1201) may form a single, integral element rather than taking on the form of separate elements. Thus, the term “a plurality of receptors”, as used in the present description, includes embodiments wherein a single element includes a plurality of receptor portions. In such an embodiment the receptors are electrically isolated from one another.

A sensor for detecting a propagation direction of electromagnetic energy includes a plurality of receptors oriented in different directions for absorbing at least a portion of the electromagnetic energy, each of the plurality of receptors comprising a plurality of carbon nanotubes or nanofibers. The sensor further includes a processor electrically coupled with the plurality of receptors for determining the propagation direction of the electromagnetic energy based upon the electromagnetic energy absorbed by the plurality of receptors.

In another aspect, a method for determining a propagation direction of electromagnetic energy includes providing a plurality of receptors oriented in different directions for absorbing at least a portion of the electromagnetic energy, each of the plurality of receptors comprising a plurality of carbon nanotubes or nanofibers. The method further includes determining the propagation direction of the electromagnetic energy with respect to the plurality of receptors based upon the amount of absorbed electromagnetic energy.

In yet another aspect a vehicle includes a fuselage and a plurality of receptors operably associated with the fuselage and oriented in different directions for absorbing electromagnetic energy, each of the plurality of receptors comprising a plurality of carbon nanotubes or nanofibers. The vehicle further includes a processor electrically coupled with the plurality of receptors for determining the propagation direction of the electromagnetic energy based upon the electromagnetic energy absorbed by the plurality of receptors.

The present invention provides significant advantages, including: (1) providing a means for determining the propagation direction of electromagnetic energy without the use of expensive lenses; (2) providing a means for determining the propagation direction of electromagnetic energy without the use of expensive antenna arrays; (3) providing a means for determining the propagation direction of electromagnetic energy that occupies less volume than conventional means for determining the propagation direction of electromagnetic energy; (4) providing a means for determining the propagation direction of electromagnetic energy that does not precipitate a change in the physical shape of a vehicle; and (5) providing a means for determining the propagation direction of electromagnetic energy that is lighter in weight than conventional means for determining the propagation direction of electromagnetic energy.

Additional objectives, features and advantages will be apparent in the written description which follows. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below. It is apparent that an invention with significant advantages has been described and illustrated. Although the present invention is shown in a limited number of forms, it is not limited to just these forms, but is amenable to various changes and modifications without departing from the spirit thereof.

What is claimed is:

1. A sensor for detecting a propagation direction of electromagnetic energy, the sensor comprising:
a plurality of receptors oriented in different directions for absorbing at least a portion of the electromagnetic energy, each of the plurality of receptors comprising a plurality of carbon nanotubes or nanofibers; and
a processor electrically coupled with the plurality of receptors for determining the propagation direction of the electromagnetic energy based upon the electromagnetic energy absorbed by the plurality of receptors.

2. The sensor, according to claim 1, wherein the plurality of carbon nanotubes or nanofibers of at least one of the plurality of receptors is in mat form.

3. The sensor, according to claim 1, wherein at least one of the plurality of receptors comprises:
a densified, electronically-conducting, anisotropic, carbon nanotube, aerogel sheet.

4. The sensor, according to claim 1, wherein the sensor comprises:
three or more receptors.

5. The sensor, according to claim 1, wherein the plurality of receptors is adapted to absorb electromagnetic energy of a certain wavelength.

6. The sensor, according to claim 1, wherein the plurality of receptors is adapted to absorb electromagnetic energy exhibiting a wavelength within a selected range of wavelengths.

7. The sensor, according to claim 1, wherein at least one of the plurality of receptors is operatively associated with an external surface of a structure.

8. The sensor, according to claim 1, wherein at least one of the plurality of receptors is disposed within a structure.

9. A method for determining a propagation direction of electromagnetic energy, comprising:
providing a plurality of receptors oriented in different directions for absorbing at least a portion of the electromagnetic energy, each of the plurality of receptors comprising a plurality of carbon nanotubes or nanofibers; and
determining the propagation direction of the electromagnetic energy with respect to the plurality of receptors based upon the amount of absorbed electromagnetic energy.

10. The method, according to claim 9, wherein the step of determining the propagation direction is accomplished by comparing an amount of electromagnetic energy absorbed by each of at least two of the plurality of receptors expressed as percentages of a total amount of electromagnetic energy absorbed by the at least two of the plurality of receptors.

11. A vehicle, comprising:
a fuselage;
a plurality of receptors operably associated with the fuselage and oriented in different directions for absorbing electromagnetic energy, each of the plurality of receptors comprising a plurality of carbon nanotubes or nanofibers; and
a processor electrically coupled with the plurality of receptors for determining the propagation direction of the electromagnetic energy based upon the electromagnetic energy absorbed by the plurality of receptors.

12. The vehicle, according to claim 11, wherein the plurality of carbon nanotubes or nanofibers of at least one of the plurality of receptors is in mat form.

13. The vehicle, according to claim 11, wherein at least one of the plurality of receptors comprises:
a densified, electronically-conducting, anisotropic, carbon nanotube, aerogel sheet.

14. The vehicle, according to claim 11, wherein the plurality of receptors comprises:
three or more receptors.

15. The vehicle, according to claim 11, wherein the plurality of receptors is adapted to absorb electromagnetic energy of a certain wavelength.

16. The vehicle, according to claim 11, wherein the plurality of receptors is adapted to absorb electromagnetic energy exhibiting a wavelength within a range of wavelengths.

17. The vehicle, according to claim 11, wherein at least one of the plurality of receptors is operatively associated with an external surface of the fuselage.

18. The vehicle, according to claim 11, wherein at least one of the plurality of receptors is disposed within the fuselage.

19. The vehicle, according to claim 11, wherein the fuselage comprises:
a nose of the vehicle.

20. The vehicle, according to claim 11, wherein the fuselage comprises:
a fuselage of the vehicle.

21. The vehicle, according to claim 11, wherein the fuselage comprises:
at least one control surface of the vehicle.

22. The vehicle, according to claim 11, wherein the vehicle is a ground-traveling vehicle.

23. The vehicle, according to claim 11, wherein the vehicle is an airborne vehicle.

24. The vehicle, according to claim 11, wherein the vehicle is a waterborne vehicle.

25. The vehicle, according to claim 11, wherein the vehicle is a missile.
